(19) United States
(12) Patent Application Publication
(10) Pub. No.: US 2019/0180597 A1
(43) Pub. Date: Jun. 13, 2019

(54) PERSON RECOGNITION BY WAY OF A CAMERA

(71) Applicant: OSRAM GmbH, Munich (DE)

(72) Inventors: Ling Wang, Eching (DE); Herbert Kaestle, Traunstein (DE); Fabio Galasso, Garching (DE); Yi Li, Munich (DE)

(21) Appl. No.: 16/214,167

(22) Filed: Dec. 10, 2018

(30) Foreign Application Priority Data
Dec. 13, 2017 (DE) 10 2017 222 675.7

(51) Int. Cl. G08B 21/22; G06T 7/00; G06T 7/246; G06K 9/20; G06K 9/00

(52) U.S. Cl. CPC G08B 21/22; G06T 7/0008; G06K 9/00221; G06K 9/209; G06T 7/246

(57) ABSTRACT

A method for recognizing the presence of at least one person in a specified spatial region by way of at least one camera is provided. The method may include recording a sequence of images of the spatial region by way of the at least one camera, performing a person recognition on the basis of at least one image of the image sequence, and then classifying or remaining classified a person object recognized by way of the person recognition as a real person if it is possible to assign to the person object a movement that has been recognized by an image evaluation of a plurality of images of the image sequence.

### CROSS-REFERENCE TO RELATED APPLICATION

This application claims priority to German Patent Application Serial No. 10 2017 222 675.7, which was filed Dec. 13, 2017, and is incorporated herein by reference in its entirety.

### TECHNICAL FIELD

Various embodiments relate generally to a method for recognizing the presence of at least one person in a specified spatial region by way of a camera, in which a sequence of images of the spatial region is recorded by way of the camera. Various embodiments also relate generally to an image-processing monitoring system, having at least one camera, which monitors a specified spatial region, an evaluation device for evaluating the images recorded by the at least one camera, wherein the monitoring system is set up to perform the method according to the invention. Various embodiments are applicable e.g. for monitoring spaces or rooms within a building.

### BACKGROUND

Hitherto, presence detection of persons in specific spatial regions, for example of a building, has typically been performed using motion sensors, for example using infrared motion sensors. However, a disadvantage here is the occurrence of false messages, because infrared motion sensors only imprecisely differentiate between persons and other moving objects or exhibit a trigger threshold which is too high or too low.

It is likewise known to perform presence detection of persons using cameras by way of image-processing methods.

In a further disadvantage, false messages can also arise when objects in the images recorded by the camera(s) that strongly resemble living persons are recognized as being persons.

Such objects can be, e.g., mannequins, photographs or paintings of persons depicted thereon etc.

### SUMMARY

A method for recognizing the presence of at least one person in a specified spatial region by way of at least one camera is provided. The method may include recording a sequence of images of the spatial region by way of the at least one camera, performing a person recognition on the basis of at least one image of the image sequence, and then classifying or remaining classified a person object recognized by way of the person recognition as a real person if it is possible to assign to the person object a movement that has been recognized by an image evaluation of a plurality of images of the image sequence.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a possible sequence of the method; and

FIG. 2 shows a possible sequence of a recognition of a moving object.

### DESCRIPTION

The following detailed description refers to the accompanying drawings that show, by way of illustration, specific details and embodiments in which the invention may be practiced.

Various embodiments at least partially overcome the disadvantages of the prior art and e.g. to provide an image-processing method for person recognition by way of which false recognition of persons is reduced.

Various embodiments provide a method for recognizing the presence of at least one person in a specified (“monitored”) spatial region by way of at least one camera, in which a sequence of images of the spatial region is recorded by way of the at least one camera, person recognition is performed on the basis of at least one image of the image sequence, and a person object recognized by way of the person recognition is then classified, or remains classified, as a real person if it is possible to assign to the person object a movement that has been recognized by an image evaluation of a plurality of images of the image sequence.

This method offers the effect that a plausibility check is provided on the basis of which it is possible to reduce, by evaluating a previous movement or a movement history of persons, a false-recognition rate thereof.

The method is based on the idea that “person objects” recognized by way of classical person recognition are classified or confirmed as actual or real persons only if they (NB: this will be mentioned later in the form of a dependent claim) have previously (NB: this will be mentioned later in the form of a dependent claim) moved. In other words, the method is based on the idea, in addition to a person recognition, to evaluate a previous movement or a movement history and link it to the person recognition.

A “person object” can be understood to mean e.g. initially any person that has been recognized as a person only by way of classical person recognition based on image processing of an image. A person object consequently also includes any purported or ostensible persons (wall images, dolls, paintings, photographs etc.) which in reality are not persons. In person recognition, in addition to the recognition of a person object, the position thereof is generally also determined.

An actual or “real” person can be understood to mean a person object that has been determined in a plausibility check as an actual person on the basis of a movement history.

The specified spatial region can correspond to a monitoring region or a field of view of the at least one camera. The specified spatial region can be, e.g., a predetermined space (e.g., a predetermined room) of a building, and possibly includes an access region to the room, such as a hallway or corridor.

The camera can record the sequence of images e.g. by way of a specified rate (“frame rate”). An image can generally also be referred to as “frame” or correspond to a frame. The camera may be a digital camera.

In one refinement,
in each case a person recognition is performed on the basis of a plurality of images of the image sequence,
a check is performed as to whether at least one same person object, recognized in a plurality of images, has already moved (i.e., in the past),
if so, the recognized person object is classified, or remains classified, as a real person, and
if not, the recognized person object is not classified, or does not remain classified, as a real person.

In this refinement, the classical person recognition as such is also used for movement recognition. This gives the effect that an algorithm for movement recognition which is separate from person recognition is not needed.

This refinement can also be referred to as “tracking by detection.” It is possible here e.g. to track the position of the recognized person object, which has also been recognized by way of the person recognition, over time, e.g. in the form of a movement trajectory, in which the positions are stored together with the respective timestamps.

If it has not been possible to recognize a movement for a detected person object, the person object is not classified as a real person, but is classified, e.g., as a moving yet non-human object (“non-person”) or as an object that has been falsely identified as a person by the person recognition (“false positive”).

It is a development that a classical person detection is performed in each image or frame of the image sequence, wherein the positions of the recognized person objects are recorded. In other words, person objects are recognized in a plurality of successive images, and the positions thereof in the spatial region are determined.

If the positions for a predetermined person object have changed, this can be equated to a movement of said person object, whereupon the person object is classified (possibly with a positive movement criterion, as will be described further below) as a real person.

This refinement is able to be employed advantageously e.g. when the person recognition can be performed so fast that a movement of a person object in the monitored spatial region is recognizable reliably, or without gaps, e.g. the images are evaluable in sufficiently short time intervals by way of the person recognition.

It is an alternative or additional refinement that
a check is performed by way of a pattern recognition based on a plurality of images of the image sequence whether at least one object recognized in the images (referred to below without limitation of generality as a “pattern object”) has moved,
person recognition is performed on the basis of at least one image of the image sequence,
a moving pattern object is classified or remains classified as being associated with a real person if it is possible to assign to the pattern object which has (in the past) moved a person object that is recognized on the basis of the person recognition,

and/or
a person object that is recognized on the basis of the person recognition is classified as a real person if a pattern object which has moved is assignable thereto or can be assigned thereto.

In this refinement, a movement of an (“abstract”) pattern object, which may represent a person, is thus registered and plausibility-checked by a person recognition. The pattern objects are here initially not recognized as person objects. Following a movement of pattern objects over a plurality of images e.g. corresponds to following positions of recognized patterns or pattern objects over a plurality of images, which can also be referred to as “tracking.” Tracking-by-movement algorithms are generally well-known and will therefore not be described in more detail here.

With this refinement, the effect may be obtained that a movement in the images is determinable e.g. short time intervals and that the method is consequently performable very quickly. This utilizes the fact that a movement recognition by way of tracking-by-movement is frequently performable much faster than person recognition. Using the possibly slower person recognition, which is therefore performed at greater time intervals, it is possible to check whether the pattern object corresponds to a person.

A plausibility check can give a positive result for example when a pattern object is situated at the same time or almost the same time within a specified minimum distance from a person object recognized by way of the person recognition.

If it is not possible to assign a person object to a pattern object which has moved, it is not possible to assign a pattern object which has moved to a person object.

If the person object or the moving pattern object is not classified as a real person, but is classified, e.g., as a moving yet non-human object (“non-person”) or as a person object that has been falsely identified as a person by the person recognition (so-called “false positive”).

In one example, a moving pattern object can be a moving piece of furniture (such as a chair, a cabinet etc.) or a pet etc., which is rejected or suppressed due to the missing person recognition. In a further example, photographs of persons, a mannequin, a statue, a coat rack etc. may have been recognized as person objects by way of the person recognition, but are rejected or suppressed due to an insufficient movement history.

It is a refinement that a person recognition is performed only in partial image regions (ROI, “regions of interest”) in which previously a movement of pattern objects has been recognized. The pattern objects have been recognized e.g. by pattern recognition over the entire image region of the recorded images. This refinement may offer the effect that a processing time for the person recognition can be reduced. The person recognition can here also be performed for partial image regions or for pattern objects which have previously moved but are currently (i.e., at the time of recording of the image that is recorded for person recognition) no longer moving. It is thus possible using this refinement for e.g. only pattern objects which are moving or have moved to trigger the person recognition, which permits particularly fast person recognition because only those partial image regions in which the movement takes or took place need to be examined. If the pattern object stays standing without moving, in a development a person recognition nevertheless continues to be performed at that location locally in the associated partial image region (at least for a specified time period, which will be described further below). This refinement can imply e.g. a prior movement history for the person objects which are recognized in these image regions using the person recognition, with the result that, in a development, person objects which are recognized there can automatically be classified as real persons.

It is a refinement that a person recognition is performed only in ROI image regions in which previously an end point of a movement of pattern objects has been recognized. This may still further reduce data processing complexity for person recognition. An ROI image region can be for example a region of a specified shape and/or size which is placed around a single or a plurality of recognized positions of pattern objects that have moved.

It is a refinement that a person recognition is performed only in ROI image regions in which a movement of pattern objects has been recognized within a specified past time period. This opens up the possibility of no longer taking into account movements of pattern objects which took place long ago. Such a time period can be, e.g., half an hour, an hour etc.

It is an alternative refinement that the person recognition is applied to the entire image region of an image. If a person object is recognized or has been identified using the person recognition, a check is performed as to whether a pattern object which has moved, is recognized by way of the pattern recognition and can be assigned to the person object is present.

In both cases, the link between person objects and movements of pattern objects can be further plausibility-checked, for example on the basis of conditions for the movements of the pattern objects (e.g., as described further below).

It is a refinement that, between two images which are evaluated for directly successive person recognitions, at least one image is additionally evaluated for the movement recognition of objects. This corresponds to a method in which, within a predetermined time period (which may correspond to at least a time period within which two images are used for a person recognition) more images are evaluated for the movement recognition than for the person recognition. For example, for an evaluation of an image for person recognition, a first time period of five seconds may be required, while for an evaluation of an image for pattern-based movement recognition only 0.1 second is required.

Within the five seconds for person recognition, e.g., 50 images can then be evaluated for the pattern recognition. This refinement may offer the effect that a particularly precise and reliable movement recognition is performable.

Generally, there is no need to evaluate each of the images of an image sequence, specifically neither for the person recognition nor for the movement recognition. However, it is possible to evaluate each of the images of an image sequence at least for the pattern recognition, which may achieve not to lose any context.

It is a development that a position of at least one pattern is tracked using the tracking method over a plurality of images of the image sequence and a movement is deduced from a change in the position.

It is e.g. a refinement that the pattern object or the pattern that is assigned to the pattern object is generated again based on a recognized person object if the person object that is recognized on the basis of the person recognition in the image is assigned to a moving pattern object, or vice versa. This can also be referred to as “re-initialization” or “refreshing.” This consequently may provide the effect that a particularly reliable movement recognition is performable. This refinement utilizes the finding that a pattern can change over the course of an image sequence, e.g., depending on an image background, and therefore tracking of the pattern becomes increasingly unreliable with the continuous duration of the tracking-by-movement method. Due to the regeneration of the pattern on the basis of the associated recognized person, this “degradation” of the pattern can be counteracted.

It is a refinement that a movement track or “movement trajectory” is stored or recorded for e.g. a moving object. The recording of a movement trajectory offers the effect that the method can be embodied particularly efficiently. The movement trajectory may include the position of the object that is determined for each evaluated image, e.g. with an associated timestamp. The movement trajectory may thus include a collection of positions (x,y) and times t, e.g., in the form of vectors <x, y, t>, determined for each image.

In this refinement, and also below, an “object” can be understood to mean a pattern object and/or a person object, as long as this is not expressly excluded. The movement trajectory of a moving object has a length>zero (e.g., in meters) and a duration>zero (e.g., in minutes).

It is a development that the movement trajectory includes the positions from three or more images which are evaluated for the movement recognition.

It is a refinement of the tracking-by-movement method, which may be provided e.g. when using a movement trajectory, that
a pattern-based object recognition or pattern recognition for pattern objects is performed on the basis of an image,
a check is performed for at least one recognized pattern object whether a movement trajectory which is determined from preceding images is assignable to said pattern object, and
if so, a position and a time of the pattern object are added as a point of the assigned movement trajectory.

This refinement may have the effect that there is no need to cache an image of the pattern objects. Rather, a movement trajectory for each pattern object is determined and assigned. A comparison of a potential person to an object can consequently be performed e.g. as a comparison of a position of a person object to a movement trajectory. This may save computation time.

Adding the position and the time of the pattern object as a point of the assigned movement trajectory includes e.g. that the movement trajectory or the movement history is permanently updated.

It is a development that a potential person recognized by way of the person recognition and an object or a movement trajectory are linked to one another or remain linked to one another only if at least one further condition is met. The condition may relate e.g. to the movement trajectory.

It is a refinement that a moving object or an object which has moved (pattern object and/or person object) is classified or remains classified as being associated with a real person if said object has previously been recognized only within a specified partial spatial region. In this way, a plausibility check for the presence of a real person is further refined. This refinement may include e.g. that objects which are not recognized or have not been recognized in the at least one specified partial spatial region are not assigned a person, or vice versa. In other words, an object must have been situated in the specified partial spatial region e.g. for a time for said object to be classified as a real person. This can also be expressed by saying that a movement trajectory of a real person runs through the specified partial spatial region. A movement trajectory for a predetermined object is thus stored or remains stored e.g. (e.g. is stored only) if it runs through the specified partial spatial region.

It is a refinement that the at least one partial spatial region corresponds to an entry region of a space or room or the like. As a result, objects (or the movement trajectories thereof) are, e.g., not classified as real persons if it has not been possible to recognize that they are moving or have moved into the room through the entry region.

It is a refinement that an object which has moved (pattern object and/or person object) is classified as being associated with a real person and/or a potential person is classified or remains classified as a real person or as being associated with a real person if said object has previously moved for a first specified time period. This permits an even further refined plausibility check for the presence of a real person. This includes e.g. that the object first of all has to have moved in the past, specifically e.g. generally independently of how long before the current time the person has moved for this time period or independent of a time interval to the current time. If this condition is not met, e.g., the object or an associated movement trajectory can be deleted.

It is a refinement that an object which has moved (pattern object and/or person object) is classified or remains classified as a real person or as being associated with a real person if said object has moved for a first specified time period within a specified partial spatial region. A movement trajectory for a predetermined object is thus stored or remains stored e.g. (e.g. is stored only) if it has been recognized within the specified partial spatial region. This permits an even further refined plausibility check for the presence of a real person. This is based on the assumption that a real person should have been situated in the partial spatial region at least for the first specified time period. In this way, short-term movements of person-like objects can be more reliably excluded. The first specified time period for this refinement can be e.g. a few seconds, e.g., 5 seconds.

It is a refinement that an object (pattern object and/or person object) is no longer classified or no longer remains classified as being associated with a person if it has not moved again for a second specified time period after a previous movement.

This permits an even further refined plausibility check for the presence of a real person. What is utilized here is that real persons generally are not able to keep still over prolonged time periods within the range of the second specified time period (e.g., 30 minutes) in a manner such that their movement cannot be recognized by way of the resolution of a camera-based monitoring system (including a detection location accuracy, e.g., of 20 cm to 30 cm). If this condition is not met, e.g., the object or an associated movement trajectory can be deleted.

It is a refinement that an object which has moved is not, or is no longer, classified or does not remain classified as being associated with a real person if the object has not moved at least temporarily at a minimum speed. This permits an even further refined plausibility check for the presence of a real person. What is e.g. utilized here is that real persons typically move at least temporarily quickly within a space and not just very slowly.

It is a refinement that the minimum speed is approximately 1.25 m/s, which is somewhat lower than a typical walking speed of a human being. If this condition is not met, e.g., the object or an associated movement trajectory can be deleted.

It is a refinement that an object (pattern object and/or person object) which has not moved is not, or is no longer, classified as being associated with a real person if the object has not moved at least temporarily at a minimum speed within a specified partial spatial region (e.g. access region). This permits an even further refined plausibility check for the presence of a real person. What is utilized here is that real persons typically move quickly within predetermined partial spatial regions, e.g., when they walk toward a space or enter a space.

It is a refinement that an object which has moved is not, or is no longer, classified or does not remain classified as a person if the object has not moved by at least a first specified minimum distance. This permits an even further refined plausibility check for the presence of a real person. What is utilized here is that a real person typically moves within a space, e.g., a room, not just over a very small area. In this way, small movements of person-like objects can be more reliably excluded.

The first minimum distance can be, e.g., one meter. This can also be expressed by saying that the length of a movement trajectory must be at least as long as the first minimum distance. If this condition is not met, e.g., the object or an associated movement trajectory can be deleted.

It is a development that a movement is recognized or remains recognized as a movement of a real person if the object which has moved has moved within the second specified time period by at least a second specified minimum distance, e.g., 0.1 to 0.5 meters within half an hour to an hour. In this way, even seated real persons can advantageously be recognized as such, because even seated persons will perform minor movements, e.g., adjusting their seat, shifting in their seat etc. If this condition is not met, e.g., the object or an associated movement trajectory can be deleted.

Generally, the method can be used to control functions associated with the specified spatial region in dependence on the presence of persons which are classified as real. Such functions can include control of illumination (e.g., turning luminaires on and off), control of network access points (e.g., turning wireless routers on and off), control of further electrical devices (e.g., monitors, coffee machines, ventilation etc.), access control etc.

Various embodiments provide an image-processing monitoring system, having
at least one camera monitoring a specified spatial region, and
an evaluation device for evaluating the images recorded by way of the at least one camera,
wherein the monitoring system is set up to perform the method according to various embodiments.

The monitoring system can be embodied analogously to the method and offers the same effects.

The monitoring system can be set up to control functions associated with the specified spatial region (e.g., as described above) in dependence on the presence of persons which are classified as real.

The monitoring system can represent a part of or a functionality of a light control system. The monitoring system can represent a part of or a functionality of a building management system (which may also include a light control system).

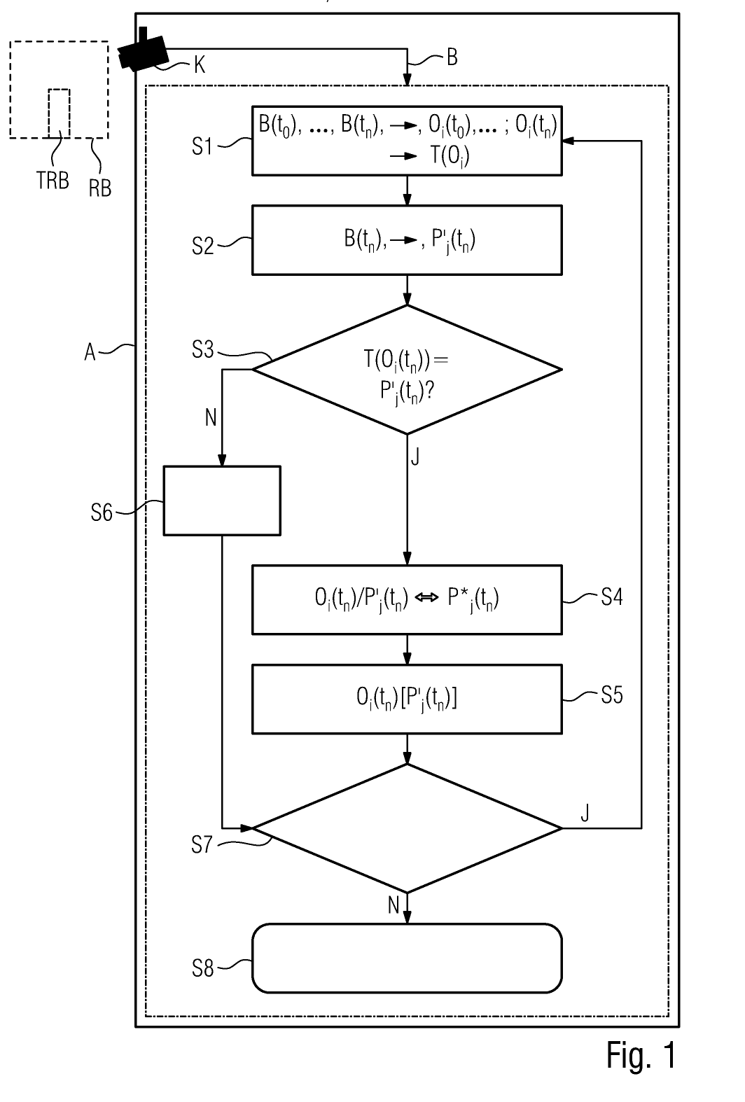

FIG. 1 shows a possible sequence of the method. For performing the method, a camera K continuously records a sequence of images B at a predetermined frame rate. The camera K is coupled to an evaluation device A, which is used for performing the method.

In S1 of the method, images B(t₀) to B(tₙ) recorded at times t₀ to tₙ are evaluated by performing in each case a pattern-based object recognition on the basis of said images B(t₀) to B(tₙ). Here, for the i pattern objects Oᵢ(t₀) to Oᵢ(tₙ), with i=1, 2, . . . , recognized in the images B(t₀) to B(tₙ) (where present) a respective movement trajectory T(Oᵢ) or T(Oᵢ(t₀)−Oᵢ(tₙ)) is created. If a length of a movement trajectory T(Oᵢ)=0, it is discarded. The remaining movement trajectories T(Oᵢ)>0 correspond to pattern objects Oᵢ or image patterns which have moved in the sequence of the images B(t₀) to B(tₙ).

In S2, a person recognition is also performed for the image B(tₙ). As a result of the person recognition, no, one or more person objects P′ⱼ with j=1, 2, . . . can be recognized.

In S3, the evaluation device A attempts to link the person objects P′ⱼ (where present), which were recognized in S2, to a respective (remaining) movement trajectory T(Oᵢ). The linking can be effected for example in a manner such that a check is performed as to whether at the time tₙ a movement trajectory T(Oᵢ) ends at a spatial position or in a region at which, in S2, at the same time tₙ a potential person P′ⱼ was recognized.

If a match T(Oᵢ)=P*ⱼ is recognized (“J”), in S4, the associated pattern object Oᵢ is classified as being associated with a real person P*ⱼ and/or the associated person object P′ⱼ is classified as a real person P*ⱼ.

In optional S5, which may follow S4, the pattern assigned to the moving pattern object Oᵢ can be generated again or adapted on the basis of the recognized person P′ⱼ or P*ⱼ.

If no match for a predetermined pattern object Oᵢ or person object P′ⱼ is found (“N”), in S6, the relevant movement trajectory T(Oᵢ) is deleted, the associated object Oᵢ or P′ⱼ is temporarily or permanently classified as a non-person.

After S4 or S5 and S6, an interrogation is optionally performed in S7 as to whether the method is to be continued. If yes (“J”), the procedure returns back to S1, and if not (“N”) the method is terminated in S8.

If the procedure returns to S1, the movement trajectory T(Oᵢ) can be continued, e.g. starting from the first image B, in which the associated pattern object Oᵢ was recognized.

Generally, if a person object P′ⱼ is not classified as a real person P*ⱼ, because it has not moved, the associated pattern object Oᵢ and/or person object P′ⱼ cannot be classified as a real person P*ⱼ or as a non-person permanently or until a different event occurs. For such a pattern object Oᵢ, e.g., no movement trajectory T(Oᵢ) needs to be stored or continued, and this pattern object Oᵢ is no longer assigned a person object P′ⱼ either in the further sequence of the method.

Generally, assignments or links between pattern objects Oᵢ and persons P′ⱼ or P*ⱼ can be deleted, movement trajectories T(Oᵢ) can be deleted and/or pattern objects Oᵢ and/or persons P′ⱼ or P*ᵢ cannot, or can no longer, be classified as being associated with real persons P*ᵢ if for example one or more of the following conditions is/are met:
a pattern object Oᵢ was not recognized in at least one specified partial spatial region TRB, e.g. not in an entry region to a space monitored by the at least one camera K;
a pattern object Oᵢ has not moved for a first specified time period, e.g., for five seconds. In this case, after a first recognition of the pattern object Oᵢ, a movement trajectory T(Oᵢ) is recorded, e.g., for the first specified time period and then examined with respect to at least one condition, e.g., whether it has a minimum length and/or corresponds to a minimum speed. If yes, the movement trajectory T(Oᵢ) is maintained, and if not, it is deleted;
an object Oᵢ has not moved again for a second specified time period, e.g., for 10 minutes, half an hour, an hour or the like;
an object Oᵢ has never moved at a minimum speed, e.g., at least at 1.25 m/s. This can be checked e.g. over a predetermined specified time period (e.g., within the first two minutes since the object Oᵢ was first recognized) and/or for a specified partial spatial region TRB of the spatial region RB (e.g., in an access region);
an object Oᵢ has not moved—at least for a predetermined specified time period—at least over a specified distance, e.g., within the first two minutes since the object Oᵢ was first recognized.

Generally, the conditions can be additionally or alternatively checked for persons P′ⱼ and/or P*ⱼ. A movement trajectory can then also be described or referred to, e.g., as a movement trajectory T(P′ⱼ) etc.

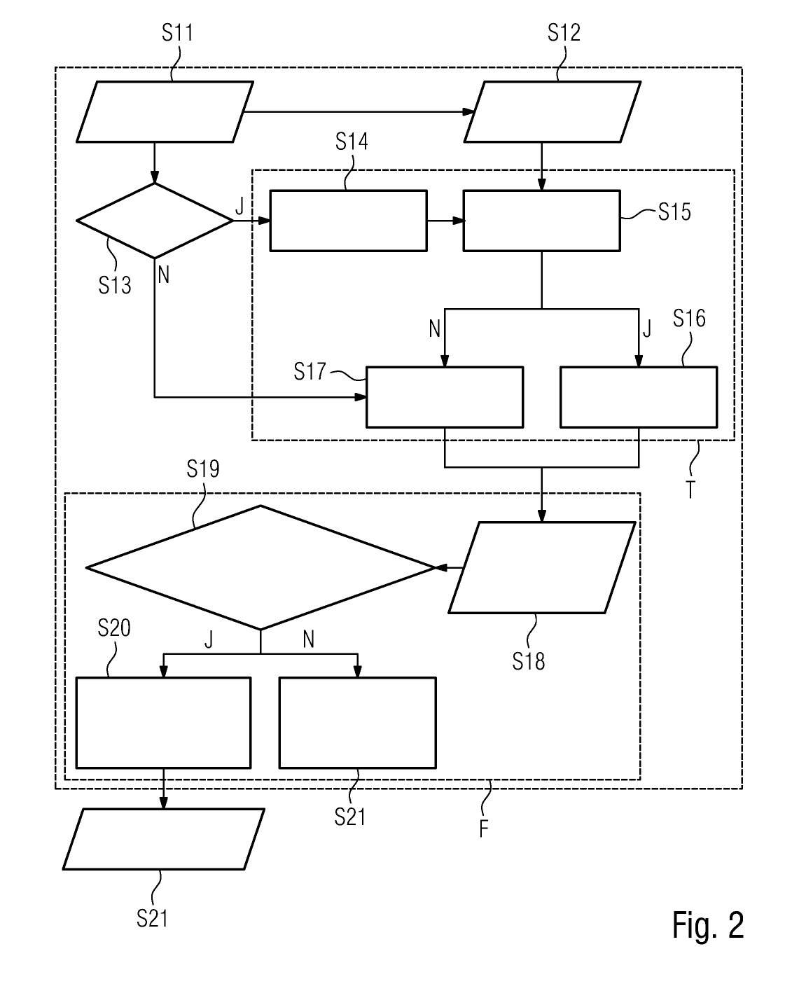

FIG. 2 shows a possible sequence of a recognition of a moving object Oᵢ. This sequence can be integrated in the method according to FIG. 1. In various embodiments, the sequence according to FIG. 2 can be understood as an itemization of the sequence according to FIG. 1.

In S11, at a time tₙ, an image B(tₙ) is recorded or adopted by the at least one camera K.

In S12, which may follow S11, a person recognition is performed in the image B(tₙ), e.g., analogously to S2 of FIG. 1.

In addition, in S13, which may follow S11, a check is performed as to whether at least one movement trajectory T(Oᵢ) already exists.

If so (“J”), in S14, which may follow S13, the at least one movement trajectory T(Oᵢ) is continued—without reference to the person recognition from S12—for image B(tₙ). The images B can thus be evaluated by way of the pattern recognition e.g. independently of a person recognition.

In S15, a check is performed as to whether the person objects P′ⱼ recognized in S12 correspond to an already existing movement trajectory T(Oᵢ) resulting from S14. This can be implemented for example such that a check is performed as to whether the end points of the already previously determined movement trajectories T(Oᵢ) are situated within a specified minimum distance/minimum radius with respect to the person objects P′ⱼ identified in S12.

If this is the case (“J”), in S16, the person objects P′ⱼ identified in S12 are assigned the closest movement trajectory and the corresponding movement trajectory T(Oᵢ) is continued from the position of the associated person object P′ⱼ.

If this is not the case (“N”), in S17, a new movement trajectory T(Oᵢ) is produced for a recognized person object P′ⱼ, for which no movement trajectory T(Oᵢ) exist yet.

S14 to S17 can be assigned to a tracking sequence T.

S16 and S17 may be followed by S18, in which only the movement trajectories T(Oᵢ) which already existed before a time tₙ₋ₚ (with p≥1) are found or filtered out.

The time period (tₙ−tₙ₋ₚ) can also be referred to as latency or delay time. In various embodiments, the associated image (tₙ−tₙ₋ₚ) can be the last image on the basis of which person recognition was performed. The delay time (tₙ−tₙ₋ₚ) can be, e.g., five seconds or more.

For these found movement trajectories T(Oᵢ), a check is performed in S19 as to whether they can be assigned to a real person. The movement trajectories T(Oᵢ) can here be examined as to whether they meet conditions that plausibility-check the movement trajectories T(Oᵢ) for the presence of a real person.

If a movement trajectory T(Oᵢ) that is assigned to a person object P*ᵢ has met the plausibility check condition(s) and has thus been classified as a real person P*ⱼ (“J”), the associated at least one person object P′ⱼ from the image (tₙ−tₙ₋ₚ) is then classified as a real person in optional subsequent S20. In other words, the person recognition performed for the image (tₙ−tₙ₋ₚ) is confirmed by the evaluation of the tracking-by-movement information.

If not (“N”) (that is to say if a movement trajectory T(Oᵢ) has not met the plausibility check condition(s) and was therefore not classified as a real person), the movement trajectory T(Oᵢ) is discarded in S21.

S18 to S21 can also be referred to as filtering sequence F.

Following S20 and consequently the filtering sequence F, it is possible in S22 for “filtered” or “cleaned” person objects P′ⱼ to be provided for the image (tₙ−tₙ₋ₚ), which have not been discarded and meet the above-described conditions, that is to say represent real persons P*ⱼ.

The tracking sequence T and the filtering sequence F together can also be referred to as the filtering/tracking sequence T, F.

Although the invention has been further illustrated and described in detail by way of the exemplary embodiments shown, the invention is not limited thereto, and other variations can be derived herefrom by a person skilled in the art without departing from the scope of protection of the invention.

Generally, “a,” “an” etc. can be understood to mean a singular or a plural, e.g. in the sense of “at least one” or “one or more” etc., unless this is explicitly ruled out, e.g. by the expression “exactly one” etc.

A mention of a number can also include both the stated number and a customary tolerance range, unless this is explicitly ruled out.

### LIST OF REFERENCE SIGNS

Evaluation device A
Images
Camera
Pattern object Oᵢ
Person object P′ⱼ
Real person P*ⱼ
Spatial region RB
Method process S1-S21
Time t₀
Time tₙ
Time tₙ₋ₚ
Movement trajectory T(Oᵢ)
Partial spatial region TRB

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method for recognizing the presence of at least one person in a specified spatial region by way of at least one camera, the method comprising:
recording a sequence of images of the spatial region by way of the at least one camera;
performing a person recognition on the basis of at least one image of the image sequence; and
then classifying or remaining classified a person object recognized by way of the person recognition as a real person if it is possible to assign to the person object a movement that has been recognized by an image evaluation of a plurality of images of the image sequence.

2. The method of claim 1,
wherein in each case a person recognition is performed on the basis of a plurality of images of the image sequence;
wherein a check is performed as to whether at least one same person object recognized in a plurality of images has already moved;
wherein if so, the recognized person object is classified, or remains classified, as a real person; and
wherein if not, the recognized person object is not classified, or does not remain classified, as a real person.

3. The method of claim 1,
wherein a check is performed by way of a pattern recognition based on a plurality of images of the image sequence whether at least one pattern object recognized in the images has moved; and
wherein a pattern object which has moved is classified or remains classified as being associated with a real person if it is possible to assign to the pattern object which has moved a person object that is recognized on the basis of the person recognition.

4. The method of claim 1,
wherein a check is performed by way of a pattern recognition based on a plurality of images of the image sequence whether at least one pattern object recognized in the images has moved; and
wherein a person object that is recognized on the basis of the person recognition is classified or remains classified as a real person if a pattern object which has moved is assignable thereto.

5. The method of claim 3,
wherein, between two images, which are evaluated for directly successive person recognitions, at least one image is additionally evaluated for the movement recognition of pattern objects.

6. The method of claim 4,
wherein, between two images, which are evaluated for directly successive person recognitions, at least one image is additionally evaluated for the movement recognition of pattern objects.

7. The method of claim 3,
wherein the pattern object is generated again based on a recognized person object if the person object that is recognized on the basis of the person recognition in the image is assigned or remains assigned to a pattern object which has moved, or vice versa.

8. The method of claim 4,
wherein the pattern object is generated again based on a recognized person object if the person object that is recognized on the basis of the person recognition in the image is assigned or remains assigned to a pattern object which has moved, or vice versa.

9. The method of claim 1,
wherein, a movement trajectory is stored for a moving object.

10. The method of claim 9,
wherein a pattern recognition for pattern objects is performed on the basis of an image;
wherein for at least one recognized pattern object a check is performed as to whether this pattern object is assignable a movement trajectory determined from preceding images; and
wherein if so, a position and a time of the pattern object are added as a point of the assigned movement trajectory.

11. The method of claim 9,
wherein a movement trajectory for an object which has moved is stored or remains stored if a movement of this object in at least one specified partial spatial region has been recognized.

12. The method of claim 1,
wherein an object which has moved is classified or remains classified as being associated with a real person if this object was first recognized in a specified partial spatial region.

13. The method of claim 1,
wherein an object which has moved is classified or remains classified as being associated with a real person if this object has previously moved for a first specified time period.

14. The method of claim 1,
wherein an object which has moved is no longer classified or no longer remains classified as being associated with a real person if it has not moved again for a second specified time period after a preceding movement.

15. The method of claim 1,
wherein an object which has moved is not, or is no longer, classified or does not remain classified as being associated with a real person if the object has not moved at least temporarily at a minimum speed.

16. The method of claim 1,
wherein an object which has moved is not, or is no longer classified or does not remain classified as being associated with a real person if this object has not moved at least temporarily at a minimum speed within a specified partial spatial region.

17. The method of claim 1,
wherein an object which has moved is not, or is no longer classified or does not remain classified as being associated with a real person if this object has not moved at least over a specified minimum distance.

18. The method of claim 1,
wherein a person recognition is effected only in partial image regions of the recorded images in which previously a movement of pattern objects has been recognized.

19. An image-processing monitoring system, comprising:
at least one camera monitoring a specified spatial region; and
an evaluation device configured to evaluate images recorded by way of the at least one camera;
wherein the monitoring system is configured to perform a method, comprising:
recording a sequence of images of the spatial region by way of the at least one camera;
performing a person recognition on the basis of at least one image of the image sequence; and
then classifying or remaining classified a person object recognized by way of the person recognition as a real person if it is possible to assign to the person object a movement that has been recognized by an image evaluation of a plurality of images of the image sequence.
